(19) United States
(12) Patent Application Publication
(10) Pub. No.: US 2025/0321745 A1
(43) Pub. Date: Oct. 16, 2025

(54) DEPTHWISE PARAMETER ORDERING IN NEURAL NETWORKS

(71) Applicant: ADVANCED MICRO DEVICES, INC., Santa Clara, CA (US)

(72) Inventors: Arun Coimbatore Ramachandran, Bangalore (IN); Ganesh Prasad Nagaraja, Bangalore (IN); Prakash Sathyanath Raghavendra, Bangalore (IN)

(21) Appl. No.: 18/637,016

(22) Filed: Apr. 16, 2024

(51) Int. Cl. G06F 9/38

(52) U.S. Cl. CPC G06F 9/3856; G06F 9/3885

(57) ABSTRACT

Techniques for processing input data in a neural network are disclosed. A sequence of neural network operations of at least one layer of the neural network is decomposed. Following decomposition, the sequence of neural network operations is reordered to form a reordered sequence of operations for the at least one layer. The input data for the at least one layer is then processed via the reordered sequence of operations.

### BACKGROUND

Advancements in artificial intelligence and underlying neural networks have precipitated significant increases in data volume and an insatiable demand for enhanced accuracy by those neural networks. This progression has catalyzed a significant increase in the complexity of neural network models, as evidenced by significant (sometimes exponential) growth in the quantity of parameters defining such models. Therefore, these advancements escalate the computational, memory, and power requirements necessary for their operation. In real-world scenarios, application and deployment of advanced neural network models creates a large demand for efficient neural network inference acceleration.

Large Language Models (LLMs), which are typically characterized by their vast number of parameters (ranging from a few million parameters to several billion), exemplify this demand. While having demonstrated efficacy across a wide array of real-world tasks, ranging from natural language processing to generative media capabilities, the relatively high resource requirements of LLMs highlight the importance of model inference efficiency.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 illustrates an architectural framework and data flow for a representative layer of an LLM neural network.

FIG. 2 is a schematic representation illustrating the expansion and contraction of tensor activations within and by MLP blocks in a neural network such as an LLM.

FIG. 3 illustrates a columnar blocking approach employed within a two-stage Multi-Layer Perceptron (MLP) block in accordance with some embodiments.

FIG. 4 illustrates an optimization of operational sequences within a neural network architecture utilizing attention and MLP blocks via unrolling, regrouping, and strategic weight reordering, in accordance with some embodiments.

FIG. 5 is an operational flow routine for optimizing the processing of one or more neural network layers in accordance with some embodiments.

FIG. 6 is a block diagram of a processing system designed to implement and fine-tune a neural network in accordance with one or more embodiments.

### DETAILED DESCRIPTION

The architecture underlying certain neural networks, such as many typical LLMs, includes configurations of computational circuitry that operate as Attention blocks (computational units that selectively focus on different portions of the input data, generally allowing the model to weigh the importance of those portions differently when processing information) and Multi-Layer Perceptron (MLP) blocks (one or more layers that perform a series of weighted inputs, bias additions, and non-linear activations to transform input data), with a significant portion of the associated computational resource usage attributable to the latter. These MLP blocks comprise sequences of expanding and contracting tensors. Prior approaches to enhancing LLM inference have often focused on either model architecture optimizations or hardware-specific acceleration techniques. However, these techniques have generally failed to leverage the tensor activation patterns present in MLP blocks, such as their expanding and contracting nature, to increase efficiency. Existing solutions further tend to overlook the nuanced interplay between different phases of LLM operation (e.g., prefill and decode phases), the impact of precision levels on computational efficiency, and the architectural nuances of CPU servers (e.g., cache hierarchy configurations, core and/or thread quantities and configurations, thermal and power limitations, I/O bandwidth, etc.) that may be exploited to enhance inference performance. These oversights present opportunities for optimizing LLM inference with respect to latency, cost, and computational resources.

Techniques described herein support various implementations of an Iterative Multi-Layer Perceptron Block with Parameter Splits (IMBPS) by optimizing the use of available computational resources, adapting dynamically to various operational modes and precision levels, and aligning with the architectural strengths of CPU servers. In certain embodiments, such techniques enhance the efficiency and performance of the underlying neural network, including those deployed on central processing unit (CPU) servers.

In certain embodiments, a depthwise reordering of parameters across MLP blocks is performed in order to reorganize the parameters from subsequent layers (e.g., reordering parameters of layer 2 to layer 1) to facilitate horizontal sharing of buffers. Such depthwise reordering may in some embodiments be performed following an unrolling of operations performed as part of an IMBPS block. As used herein, unrolling refers to the process of decomposing a neural network layer into individual operations to expose parallelism and optimize computational efficiency. In embodiments, this technique rearranges the computations typically encapsulated within complex network structures, enabling a more streamlined and efficient execution on hardware, often by reducing overhead and improving data access patterns within the memory hierarchy.

For example, such reordering enhances General Matrix Multiplication (GEMM) efficiency by optimizing the memory layout and utilization, thereby minimizing the activation sizes and the need for data repacking. This depthwise parameter reordering reduces computational overheads and improves the operational compatibility of neural networks with the underlying hardware architecture, further optimizing neural network inference tasks on CPU servers. By integrating depthwise parameter reordering and buffer sharing strategies, IMBPS offers a comprehensive solution to the computational and memory inefficiencies prevalent in existing neural network deployments.

In LLM architectures utilizing Multi-Layer Perceptron (MLP) blocks, such blocks are responsible for a substantial portion of the computational load through sequences of expanding and contracting activation tensors. In various embodiments, reducing the computational load is addressed by optimizing the management of these tensors, thereby mitigating the compute requirements and improving overall model efficiency.

As used herein, activation size refers to a volume of data generated by the neurons of a particular layer within a neural network during its forward pass. Such data typically comprises an array of values produced as outputs by the activation functions applied to the weighted sums of inputs to the neurons in that layer. These activation values serve as inputs to subsequent layers within the network. The size of these activations is determined by the dimensions of the output tensor for the layer, which in turn depends on factors such as the number of neurons in the layer, the batch size of the input data being processed, and the architecture of the neural network itself. In the context of Large Language Models (LLMs) and other deep learning architectures, managing activation size has significant impact on computational efficiency and memory usage optimization, particularly during inference tasks in which available computational resources are constrained. Activation size directly influences the memory footprint of the neural network model during its execution, affecting how effectively the model can be deployed on various hardware platforms.

In certain embodiments, activation sizes in IMBPS are significantly reduced by leveraging a strategic iteration over sequences of partial MLPs, such as those referred to herein as MLP1 and MLP2 blocks. This approach not only diminishes the peak activation sizes but also curtails the packing overheads associated with matrix dimensions, aligning them with the architecture of the target CPU and providing a more efficient execution of LLM inference tasks.

As used herein, packing overheads refer to computational and memory inefficiencies, such as those typically incurred during the preparation of data for processing by neural network layers. These packing overheads commonly occur during matrix operations, such as when rearranging or packing tensor data into formats that are optimized for the specific computational kernels employed by underlying General Matrix Multiplication (GEMM) libraries or hardware acceleration mechanisms. The process of packing involves additional memory accesses and data manipulations, which do not directly contribute to the computational output of the neural network but are utilized to achieve operational compatibility with a specific processing unit's architecture or to increase the utilization of its computational resources. Consequently, packing overheads can significantly impact the overall computational efficiency and performance of neural network inference, especially in scenarios where the tensor dimensions do not naturally align with the hardware's optimal processing capabilities or when the tensor sizes are such that they exacerbate the mismatch between available computational resources and the demands of the task.

Techniques described herein provide a reuse strategy for shared buffers across differing columnar MLP blocks, which effectively diminishes utilization of off-chip memory references. In certain embodiments, the quantity of splits (the number of segments into which to split the original input data) is modeled based on various operational modes, phases, precision levels, cache sizes, vectorization support, and model parameters. This approach facilitates a broad spectrum of CPU server configurations and LLM architectures.

Empirical validations of various IMBPS implementations demonstrate significant enhancements in inference acceleration across various LLM architectures. Such performance improvements not only bolster the computational efficiency but also pave the way for the deployment of generative AI capabilities on commodity hardware, thereby democratizing access to advanced AI technologies.

While various examples are described herein with particular attention to large language models, the techniques provided are applicable to various types of neural networks and neural network models, including (as non-limiting examples) convolutional neural networks (CNNs), recommender systems, and various other neural network architectures characterized by expanding and contracting patterns in MLP sequences.

The execution of LLM models typically comprises two phases: a prefill phase and a decode phase. The prefill phase operates on a vector of words in order to understand the context. As used herein, context refers to the informational background or the set of circumstances surrounding a specific piece of data, event, or computational process that influences its interpretation, processing, or outcome within a neural network, such as LLMs. In certain scenarios and embodiments, context encompasses some or all of the preceding elements and, in some models, some or all succeeding elements (such as words, tokens, or vector embeddings) that provide semantic or syntactic clues utilized for accurately predicting, generating, or understanding a current element or sequence of elements. Context guides a neural network model to generate coherent, relevant, and semantically rich outputs based on the input it receives. In LLMs, the effective leveraging and manipulation of context enable the models to exhibit a deep understanding of language nuances, grammar, and relationships between concepts, thereby enhancing their ability to perform a wide range of tasks from translation to content creation and beyond. The depth and breadth of context considered by a model greatly impact its performance and the complexity of the tasks it can effectively process.

In the decode phase, the model generates output, typically one token at a time, by leveraging the context established in the preceding phase or phases. During this decode phase, the model iteratively utilizes the contextual information accumulated from a prefill phase to predict or generate the subsequent element in a sequence. This phase is characterized by the model's application of its learned parameters and the structural intricacies of its architecture-such as attention blocks and MLP blocks—to infer the most probable subsequent token based on the provided context. The decode phase is operative for the model's generative tasks. In executing the decode phase, the model generally caches previous contexts and dynamically integrates them with the current state to produce outputs that are coherent, contextually relevant, and semantically rich.

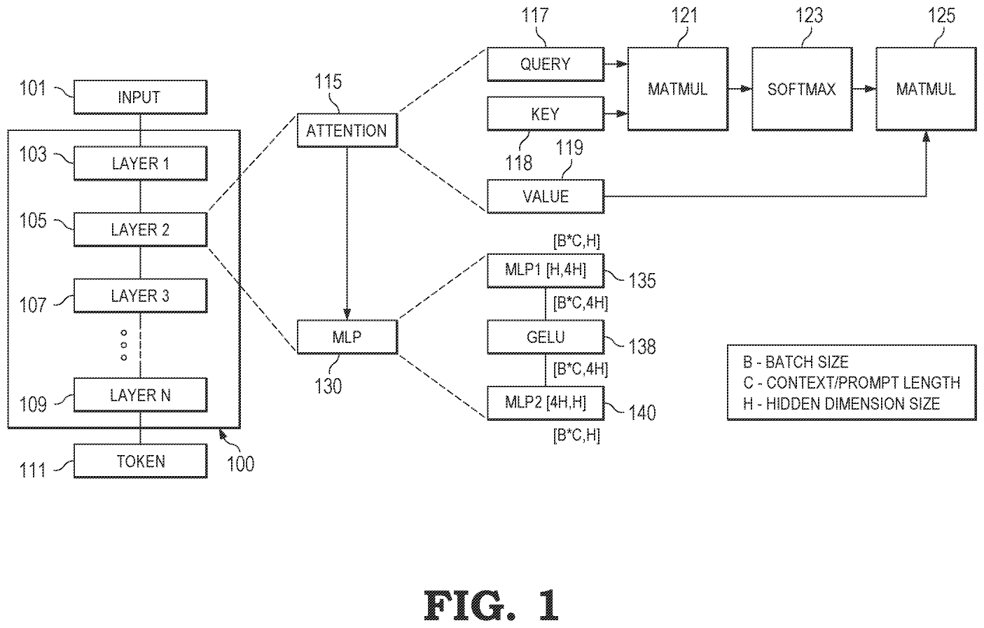

FIG. 1 illustrates an architectural framework and data flow for a representative layer of an LLM neural network 100 to display the structural and functional integration of Attention and Multi-Layer Perceptron (MLP) blocks. In the depicted scenario, input data 101 represents the initial data fed into the neural network. This input is processed via a structured sequence of neural network layers, beginning with the first layer 103, progressing through the second layer 105 and the third layer 107, and continuing sequentially until reaching the Nth layer 109, which produces token 111 as output of the neural network 100. This layered architecture underpins the neural network's capacity to perform increasingly complex transformations on the input data 101.

The second layer 105 is expanded for illustration purposes, depicting its internal operations performed via attention block 115 and MLP block 130 such that the output of attention block 115 is provided as input to MLP block 130.

In the depicted scenario, attention block 115 includes query 117, key 118, and value 119 (which generally facilitate the weighting of different parts of the input data 101 relative to each other). The query 117 and key 118 undergo a first matrix multiplication operation in matrix multiplication block 121, the result of which is then passed to a softmax block 123. The softmax block 123 applies a normalization function, transforming the output into a probability distribution that accentuates significant features while diminishing the less relevant ones. Subsequently, the output of the softmax block 123, along with the value 119 from attention block 115, feeds into a second matrix multiplication block 125, the output of which is provided as input to MLP block 130.

Also in the depicted scenario, MLP block 130 is expanded to depict internal operational blocks MLP1 block 135, Gaussian error linear unit (Gelu) activation block 138, and MLP2 block 140. The MLP1 block 135 handles initial input data having dimensions [B*C, H], denoting its basis on the batch size (B), context size (C), and hidden dimension size (H). This data is transformed within the MLP1 block 135, leading to an expanded feature space [B*C, 4H], as processed via the Gelu activation block 138. The MLP2 block 140 concludes this MLP sequence by contracting the data back to its original dimensionality [B*C, H], facilitating ease of processing by subsequent layers or operational blocks within the neural network 100.

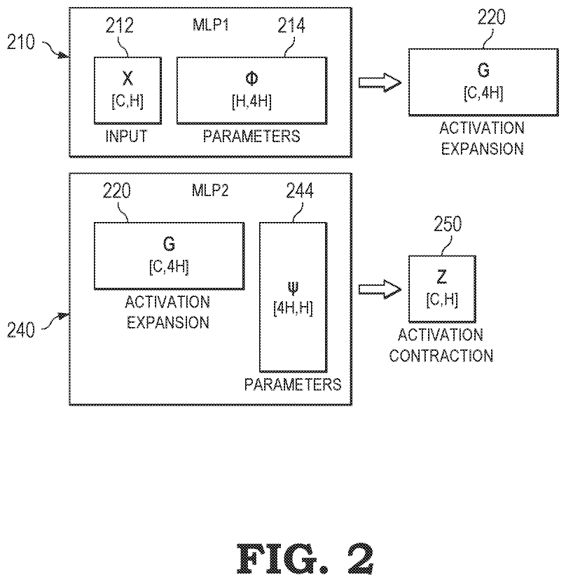

FIG. 2 is a schematic representation illustrating the expansion and contraction of tensor activations within and by MLP blocks in a neural network such as an LLM. Such operations comprise the transformative process tensors undergo as they propagate through such MLP blocks for processing.

The MLP1 block 210 first receives an input block 212, characterized by dimensions [C, H], where ‘C’ represents the context length, encapsulating the extent of sequential data the model analyzes in a single operation, and ‘H’ denotes the hidden dimension size. This configuration structures the initial interaction between the model's learned parameters and the input data.

As used herein, the hidden dimension size refers to the size of the internal representation within a neural network layer. It denotes the number of neurons or units in a hidden layer, which generally captures the amount of information or features that can be represented or processed by the layer. The hidden dimension size significantly impacts a model's capacity to learn complex patterns, with larger hidden dimension sizes generally allowing for richer representations at the cost of increased computational complexity and resource requirements. In various embodiments and scenarios, the hidden dimension size significantly impacts the balance between computational efficiency and the model's ability to understand and generate language constructs, influencing both the depth of contextual understanding and the breadth of generative capabilities.

Adjacent to input block 212 within MLP1 block 210 is the parameter block 214, having dimensions [H, 4H]. This parameter block 214 comprises the weights the neural network has learned to apply to the input data. The transition from dimensions [H] to [4H] in parameter block 214 is indicative of the network's expanded internal representational capacity, allowing for interpretation and transformation of the input data represented by input block 212.

The output of MLP1 block 210 is activation expansion block 220, which embodies the neural network's feature expansion and has dimensions [C, 4H]. The greater dimensions of the activation expansion block 220 shows the enlargement of the tensor's feature dimension, from [H] in the input block to [4H], enabling a richer representation of the input data. This expanded form is utilized for subsequent computational steps within the neural network, as the activation expansion block 220 serves as expanded input to MLP2 block 240.

In the depicted scenario, MLP2 block 240 processes the expanded tensor data input from activation expansion block 220 using parameters block 244 of dimensions [4H, H]. The parameters block 244 comprises the set of weights that the MLP2 block 240 uses to process the expanded inputs from activation expansion block 220.

The processing of the activation expansion block 220 by MLP2 block 240 results in the output activation contraction block 250, characterized by dimensions [C, H], which are identical to the dimensions of the initial input block 212.

For a prefill phase in which the batch size B is 32, context length C is 512, and hidden dimension H is 4096, the activation size for single-precision floating point 32 (FP32) format precision in MLP1 grows to 4*B*C*H=4*32*512*4096=268 MB. As the batch size and context length grow, the activation size might not fit into an L3 cache, requiring accesses to off-chip memory that negatively impact efficiency.

As indicated above, the decode phase of an LLM generates one word at a time by caching the previous contexts. For example, in a decode phase in which the batch size B is 32 and hidden dimensions H is 4096, the expanded inputs in MLP2 in 32-bit floating-point notation (FP32) is 4*B*H=4*32*4*4096=2 MB, which might be larger than Li and L2 caches for a given architecture.

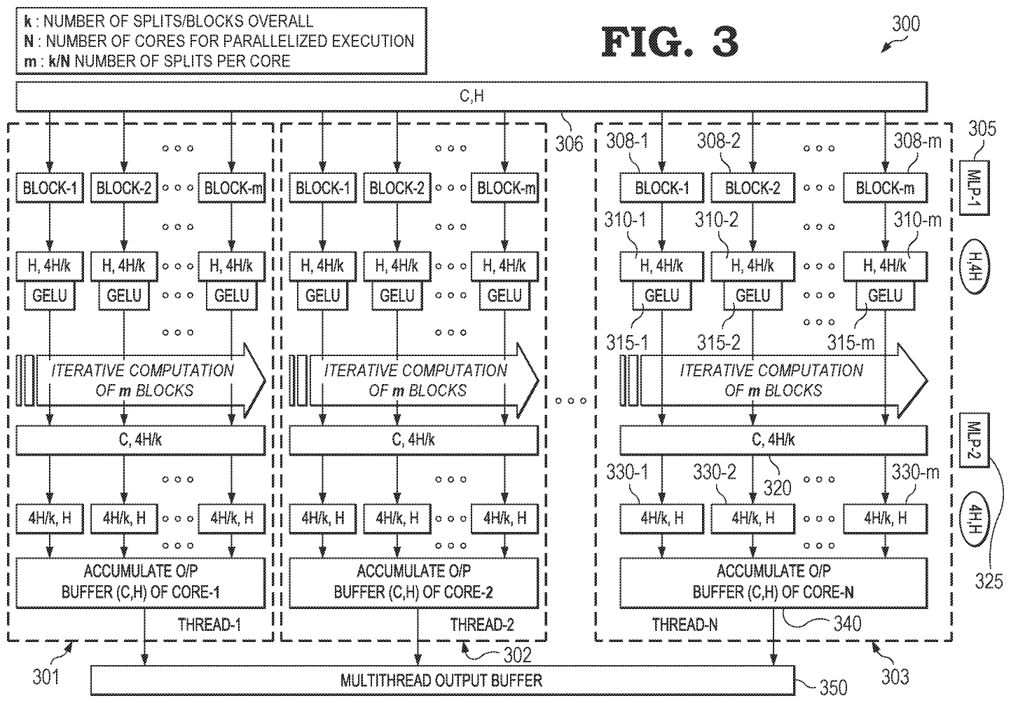

FIG. 3 illustrates a columnar blocking approach employed within a two-stage Multi-Layer Perceptron (MLP) block 300 in accordance with some embodiments, demonstrating the division and processing of input data to achieve enhanced computational efficiency and data handling for a neural network executed by a multithreaded processor.

In various embodiments, the processing of input data by one or more layers of a neural network may advantageously increase the parallelism of that processing via the lossless splitting of input data. For example, with continuing reference to the depiction of FIG. 2:

X: [C × H]
ϕ : [H × 4H) is split into k-slices across the columns,
each [H × 4H/k] for independent computation.
ϕ = [ϕ₁|ϕ₂|ϕ₃| . . . |ϕₙ]
At 1st MLP, all Yₓ = [X * ϕₓ] are computed independently.
Y = [X * ϕ₁|X * ϕ₂|X * ϕ₃| . . . |X * ϕₖ] = [Y₁|Y₂|Y₃| . . . |Yₖ]
This is followed by element-wise Gelu activation:
G = Gelu (Y₁|Y₂|Y₃| . . . |Yₖ) = [G₁|G₂|G₃| . . . |Gₖ]
G can be seen as split across the columns into k-slices.
$G = [ \begin{matrix}{g}_{11} & {g}_{12} & \cdot & \cdot & \cdot & {g}_{gK} \\ {g}_{21} & {g}_{22} & \cdot & \cdot & \cdot & {g}_{2 K} \\ {g}_{31} & {g}_{32} & \cdot & \cdot & \cdot & {g}_{3 K} \\ \cdot & & & & & \\ \cdot & & & & & \\ \cdot & & & & & \\ \cdot & & & & & \\ \cdot & & & & & \\ {g}_{M 1} & {g}_{M 2} & \cdot & \cdot & \cdot & {g}_{MK}\end{matrix} ] = [ {G}_{1} \vert {G}_{2} \vert {G}_{3} \vert … \vert {G}_{k} ]$
At 2nd MLP:
ψ: [4H × H] is split into k-slices across the rows into [4H/k × H]
for independent computations.
$ψ = [ \begin{matrix}{ψ}_{11} & {ψ}_{12} & \cdot & \cdot & \cdot & {ψ}_{1 K} \\ {ψ}_{21} & {ψ}_{22} & \cdot & \cdot & \cdot & {ψ}_{2 K} \\ {ψ}_{31} & {ψ}_{32} & \cdot & \cdot & \cdot & {ψ}_{3 K} \\ \cdot & & & & & \\ \cdot & & & & & \\ \cdot & & & & & \\ \cdot & & & & & \\ \cdot & & & & & \\ {ψ}_{n 1} & {ψ}_{n 2} & \cdot & \cdot & \cdot & {ψ}_{nK}\end{matrix} ] = [ \begin{matrix}{ψ}_{1} \\ {ψ}_{2} \\ {ψ}_{3} \\ \cdot \\ \cdot \\ \cdot \\ {ψ}_{k}\end{matrix} ]$
G * ψ can be computed independently by computing each
[Gₓ * ψ_{y}] independently and summing their results across
axis = 0.
$G * ψ = [ {G}_{1} \vert {G}_{2} \vert {G}_{3} \vert … \vert {G}_{n} ] * [ \begin{matrix}{ψ}_{1} \\ {ψ}_{2} \\ {ψ}_{3} \\ \cdot \\ \cdot \\ \cdot \\ {ψ}_{k}\end{matrix} ] = [ \begin{matrix}[ {G}_{1} * {ψ}_{1} ] \\ [ {G}_{2} * {ψ}_{2} ] \\ [ {G}_{3} * {ψ}_{3} ] \\ \cdot \\ \cdot \\ \cdot \\ [ {G}_{n} * {ψ}_{n} ]\end{matrix} ]$

Therefore, the output matrix Z (e.g., output activation contraction block 250) can be generated as an accumulation of multiple results from multiple threads, each operating in parallel to process a portion of losslessly split input data.

In the depicted embodiment of FIG. 3, operations within the MLP block 300 are performed via execution of N threads 301, 302, 303. For purposes of descriptive economy, the elements and operations within executing thread 303 (Thread-N) are described herein, with corresponding elements and operations within executing threads 301 and 302 provide substantially identical functionality as part of the respective execution of those threads 301, 302. In the context of FIG. 3 and the discussion below, ‘m’ represents the number of split input blocks (segments) allocated per core, with “N” denoting the total number of processing cores available for parallel execution. In contrast, “k” signifies the total overall number of split input blocks derived from the original input data block.

With continuing reference to FIG. 3, an original input data block 306 has dimensions [C, H], where ‘C’ again denotes the context length, and ‘H’ again represents the hidden dimension size. The original input data block 306 is losslessly divided into m split input blocks 308, respectively labeled 308-1, 308-2, and 308-m, with m being the number of blocks (out of total overall blocks k) per number of cores (N) for use in parallel execution. In certain embodiments, split input blocks 308-1, 308-2, 308-m are derived by partitioning the original input data block 306 along its feature dimension, thereby creating subsets of the data with preserved contextual integrity. In this manner, each split input block 308 maintains a portion of the original data's feature set, allowing for parallel and independent processing within the MLP1 stage 305.

In certain embodiments, the particular split of input data is performed based on the demands of specific use cases, such as the prefill/prompt phase, decode phase, or various levels of quantization. This adaptability ensures that the neural network architecture can dynamically adjust its processing techniques to optimize for efficiency and accuracy, according to the unique requirements of each operational phase. For example, during the prompt phase, in which the model prepares its initial response based on a given input (the prompt), the system may adopt a specific splitting strategy to handle the typically shorter sequences. Conversely, in the decode phase, where the model generates longer sequences of output data, a different strategy may be employed to manage the increased computational load effectively. The application of these adaptive splitting techniques enables maintaining high performance across diverse operational scenarios.

Each split input block 308 undergoes processing in the first stage of the MLP1 stage 305, individually provided for processing to corresponding first functional blocks 310 within the MLP1 stage (e.g., split input block 308-1 is input to functional block 310-1, split input block 308-2 to block 310-2, and split input block 308-m to block 310-m). The intermediate data generated and output by functional blocks 310 are respectively directed to corresponding Gelu activation blocks 315, which apply a non-linear activation function to introduce complexity and non-linearity to the data representations. Each Gelu activation block 315 (315-1, 315-2, 315-m) receives the input intermediate data from its corresponding functional block 310.

The additional intermediate data generated by and output from the Gelu activation blocks 315 are provided to a single common shared buffer 320. This shared buffer 320 enables efficient data management and access for subsequent processing stages, and the provision of all outputs to the single shared buffer limits the maximum activation size associated with operations of the MLP block 300 to that shared buffer's dimensions of [C, 4H/k] for each of the N threads.

Proceeding to the MLP2 stage 325, the intermediate data contents of the shared buffer 320 are disseminated across parallel processing blocks 330 (processing blocks 330-1, 330-2, . . . 330-m. In the depicted embodiment, the outputs of those processing blocks 330 are provided to (e.g., summed within) a single accumulate output buffer 340 having dimensions of [C, H], the same as those of the original input data block 306.

The contents of the accumulate output buffer 340 from each of executing threads 301, 302, 303 are further accumulated via multithread output buffer 350, which embodies the final processed data of the MLP block 300 and shares the dimensions [C,H] of the respective accumulate output buffer from each thread 301, 302, 303.

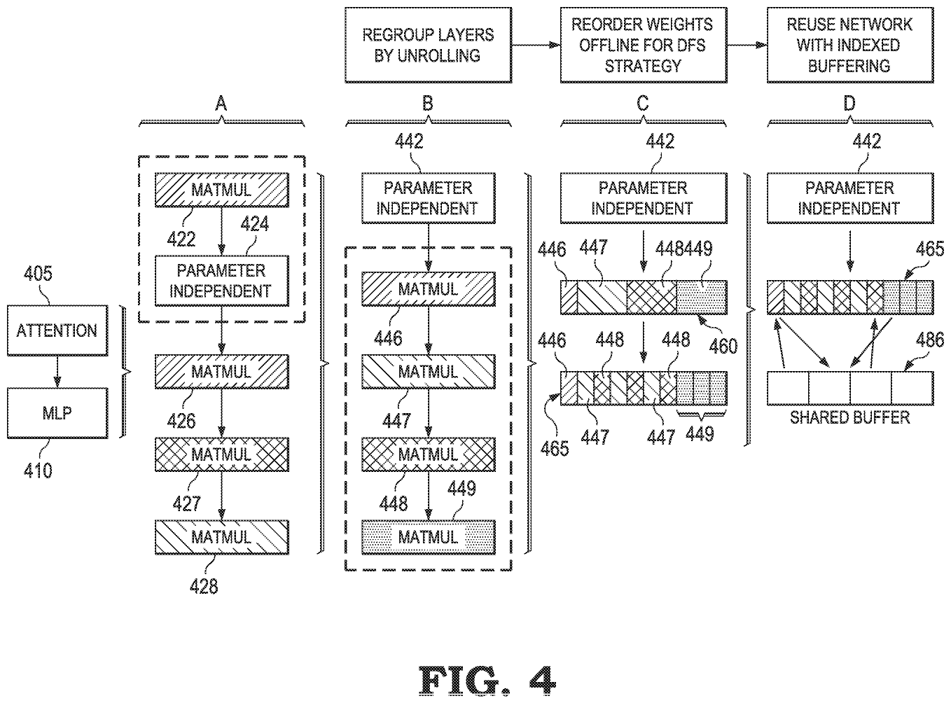

FIG. 4 illustrates an optimization of operational sequences within a neural network architecture utilizing attention and MLP blocks via unrolling, regrouping, and strategic weight reordering, in accordance with some embodiments.

To the right of an attention block 405 and an MLP block 410, column A depicts a sequence of operations comprising the attention block 405 and MLP block 410. In particular, in the depicted embodiment the attention block 405 encompasses a matrix multiplication block 422 and subsequent parameter-independent operations block 424. The MLP block 410 corresponds to a series of matrix multiplication operation blocks 426, 427, and 428, which collectively represent the typical computational pathway within these blocks as part of MLP block 410.

As used herein, parameter-independent operations refer to computational processes or functions within the neural network that do not rely on the learned parameters or weights of the neural network model to perform their tasks. These operations can include, but are not limited to, fixed mathematical transformations, normalization procedures, activation functions that do not adjust based on training data, and data reshaping or reformatting steps. In certain embodiments, such operations serve to prepare, adjust, or enhance the input data in a consistent manner, independent of the model's training state, thereby facilitating or optimizing subsequent processing stages that do involve learned parameters (weights).

In column B, the effects of unrolling and regrouping the operational sequence of operations of column A are depicted after being reorganized to execute parameter-independent operations 442 prior to consolidated matrix multiplication operations originally denoted by blocks 422 and 426 into matrix multiplication operations 446. Thus, matrix multiplication blocks 447 (comprising operations previously part of matrix multiplication block 428) and 448 (comprising operations previously part of matrix multiplication block 427) are executed in a reordered sequence, with an additional matrix multiplication operation 449 introduced, such as to compensate for effects of the reordered sequence.

In column C, the sequence of ordered operations is further modified by reordering the weights associated with operations of reordered matrix multiplication blocks 446, 447, 448, and 449. As in column B, the parameter-independent operations 442 precede a first reordered operational sequence 460 that includes the execution sequence of matrix multiplication operations 446, 447, 448, and 449 in turn. However, in reordered operational sequence 465, the operations of matrix multiplication blocks 447 and 448 are interleaved, such as to take advantage of parallel processing operations using segmented input data blocks (e.g., as described above with respect to FIG. 3). Matrix multiplication operations 449 are segmented but not interleaved.

In addition, and as Column D illustrates, the reordered operational sequence 465 enables an optimized buffer reuse, depicted via a shared buffer 486, which facilitates efficient data management between the operations of the reordered operational sequence 465.

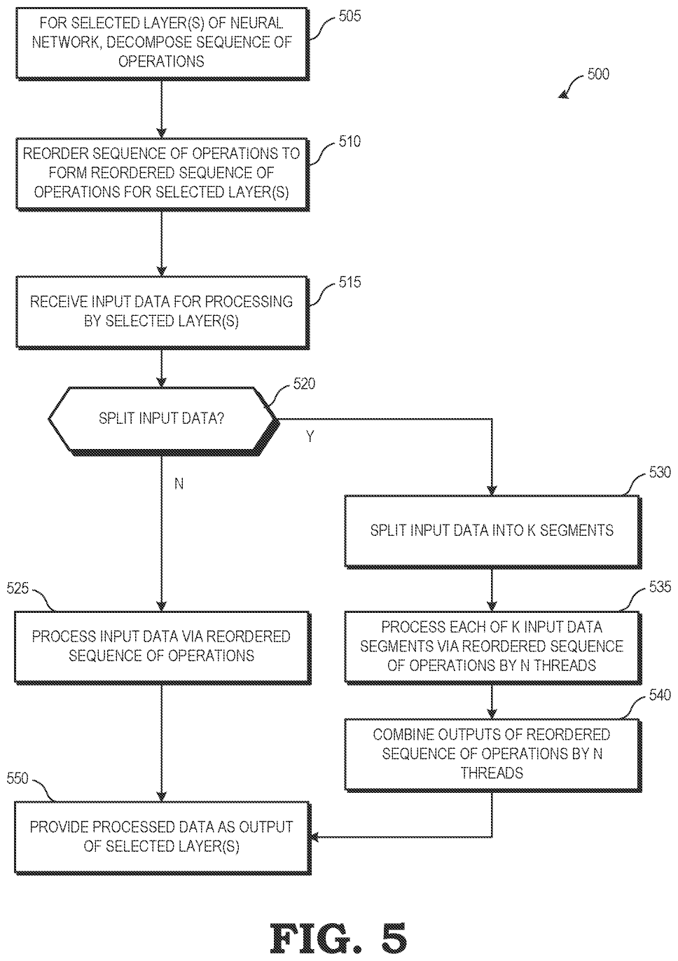

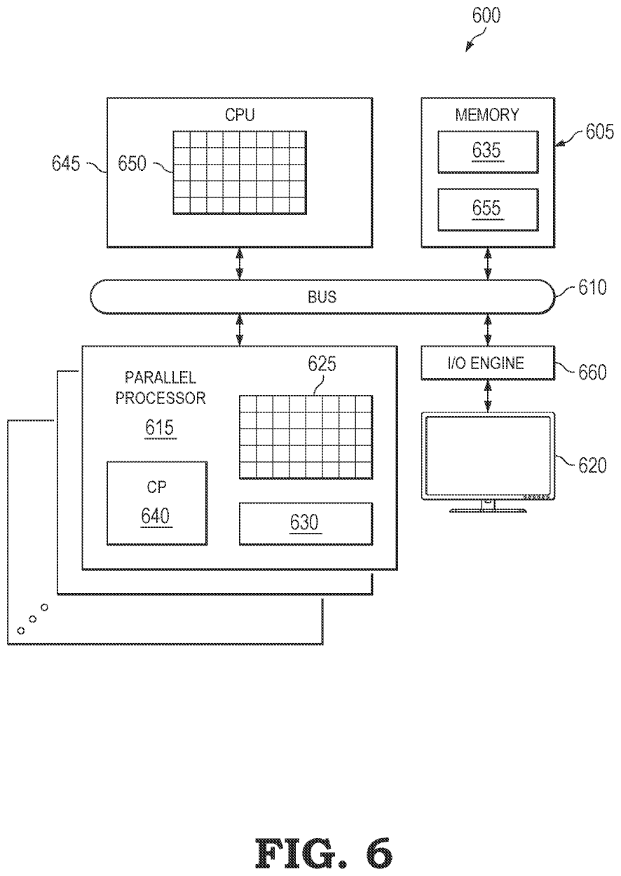

FIG. 5 is an operational flow routine for optimizing the processing of one or more neural network layers in accordance with some embodiments. The routine may be performed, for example, by a processing system executing one or more neural networks (e.g., processing system 600 of FIG. 6, described elsewhere herein), and begins at block 505.

At block 505, for one or more selected layers of a neural network (e.g., layers 103, 105, 107, 109 of FIG. 1, a layer that includes the two-stage MLP block 300 of FIG. 3, etc.), the sequence of computational operations forming that layer is decomposed into individual neural network operations. In various embodiments, such operations include, as non-limiting examples, matrix multiplication, activation functions, normalization, element-wise addition or multiplication, and data reshaping. This decomposition disaggregates complex operations into suboperations. The routine proceeds to block 510.

At block 510, the processing system modifies the sequence of operations by generating a reordered sequence of operations for the selected layer(s). As described in greater detail elsewhere herein, in certain embodiments and scenarios, such reordering may be performed in order to consolidate and/or eliminate layer dependencies, as well as to improve computational efficiency by placing parameter-independent operations ahead of parameter-dependent operations during execution of the selected layers. The routine proceeds to block 515.

At block 515, input data designated for processing by the selected layer(s) is received, setting the stage for a decision-making process represented at step 520 on whether to split the data.

If the processing system determines at block 520 not to split the input data, the routine proceeds to block 525, bypassing input data segmentation such that the received input data is directly processed in accordance with the reordered sequence of operations. The routine then proceeds to block 550.

If the processing system determined at block 520 to split the input data, the routine proceeds to step 530, where the input data is divided into K segments. This division is designed to align with parallel processing capabilities and to cater to the specific computational requirements of the neural network, as described in greater detail elsewhere herein. Following the splitting of the input data, the routine proceeds to block 535.

At block 535, each of the K segments of input data is processed via the reordered sequence of operations by K distinct processing threads. This parallel processing approach is intended to capitalize on the efficiency gains from the decomposition and reordering of operations. The routine proceeds to block 540.

At block 540 the outputs from the K threads, each having processed a segment of input data, are combined. In certain embodiments, the combined output is stored by an accumulation buffer. Following the combining of the outputs, the routine proceeds to block 550.

At block 550, the processed data whether from a single received batch of input data via block 525 or combined outputs from the processing of individual segments of split input data via blocks 535 and 540 is provided as the output of the selected layer(s). This output reflects the transformed data, ready for subsequent stages of neural network processing or for delivery as the final model output.

FIG. 6 is a block diagram of a processing system 600 designed to implement one or more neural networks in accordance with one or more embodiments. The processing system 600 is generally designed to execute sets of instructions or commands to carry out tasks on behalf of an electronic device, such as a desktop computer, laptop computer, server, smartphone, tablet, game console, and the like.

The processing system 600 includes or has access to a memory 605 or other storage component that is implemented using a non-transitory computer readable medium, such as dynamic random access memory (DRAM). The processing system 600 also includes a bus 610 to support communication between entities implemented in the processing system 600, such as the memory 605. In certain embodiments, the processing system 600 includes other buses, bridges, switches, routers, and the like, which are not shown in FIG. 6 in the interest of clarity.

The processing system 600 includes one or more parallel processors 615 that are configured to render images for presentation on a display 620. A parallel processor is a processor that is able to execute a single instruction on multiple data or threads in a parallel manner. Examples of parallel processors include graphics processing units (GPUs), massively parallel processors, single instruction multiple data (SIMD) architecture processors, and single instruction multiple thread (SIMT) architecture processors for performing graphics, machine intelligence, or compute operations. The parallel processor 615 can render objects to produce pixel values that are provided to the display 620. In some implementations, parallel processors are separate devices that are included as part of a computer. In other implementations such as advance processor units, parallel processors are included in a single device along with a host processor such as a central processor unit (CPU). Thus, although embodiments described herein may utilize a graphics processing unit (GPU) for illustration purposes, various embodiments and implementations are applicable to other types of parallel processors.

In certain embodiments, the parallel processor 615 is also used for general-purpose computing. For instance, the parallel processor 615 can be used to implement machine learning algorithms such as one or more implementations of a CNN as described herein. In some cases, operations of multiple parallel processors 615 are coordinated to execute a machine learning algorithm, such as if a single parallel processor 615 does not possess enough processing power to run the machine learning algorithm on its own.

The parallel processor 615 implements multiple processing elements (also referred to as compute units) 625 that are configured to execute instructions concurrently or in parallel. The parallel processor 615 also includes an internal (or on-chip) memory 630 that includes a local data store (LDS), as well as caches, registers, or buffers utilized by the compute units 625. The parallel processor 615 can execute instructions stored in the memory 605 and store information in the memory 605 such as the results of the executed instructions. The parallel processor 615 also includes a command processor 640 that receives task requests and dispatches tasks to one or more of the compute units 625.

The processing system 600 also includes a central processing unit (CPU) 645 that is connected to the bus 610 and communicates with the parallel processor 615 and the memory 605 via the bus 610. The CPU 645 implements multiple processing elements (also referred to as processor cores) 650 that are configured to execute instructions concurrently or in parallel. The CPU 645 can execute instructions such as program code 655 stored in the memory 605 and the CPU 645 can store information in the memory 605 such as the results of the executed instructions.

An input/output (I/O) engine 660 handles input or output operations associated with the display 620, as well as other elements of the processing system 600 such as keyboards, mice, printers, external disks, and the like. The I/O engine 660 is coupled to the bus 610 so that the I/O engine 660 communicates with the memory 605, the parallel processor 615, or the CPU 645.

In operation, the CPU 645 issues commands to the parallel processor 615 to initiate processing of a kernel that represents the program instructions that are executed by the parallel processor 615. Multiple instances of the kernel, referred to herein as threads or work items, are executed concurrently or in parallel using subsets of the compute units 625. In some embodiments, the threads execute according to single-instruction-multiple-data (SIMD) protocols so that each thread executes the same instruction on different data. The threads are collected into workgroups (also termed thread groups) that are executed on different compute units 625. For example, the command processor 640 can receive these commands and schedule tasks for execution on the compute units 625.

In some embodiments, the parallel processor 615 implements a graphics pipeline that includes multiple stages configured for concurrent processing of different primitives in response to a draw call. Stages of the graphics pipeline in the parallel processor 615 can concurrently process different primitives generated by an application, such as a video game. When geometry is submitted to the graphics pipeline, hardware state settings are chosen to define a state of the graphics pipeline. Examples of state include rasterizer state, a blend state, a depth stencil state, a primitive topology type of the submitted geometry, and the shaders (e.g., vertex shader, domain shader, geometry shader, hull shader, pixel shader, and the like) that are used to render the scene.

As used herein, a layer in a neural network is a hardware- or software-implemented construct in a processing system, such as processing system 600. In various embodiments, such a layer may perform one or more operations via processing circuitry of the processing system 600 to serve as a collection or group of interconnected neurons or nodes, arranged in a structure that can be optimized for execution on one or more parallel processors (e.g., parallel processors 615) or other similar computation units. Such computation units can, in certain embodiments, comprise one or more graphics processing units (GPUs), massively parallel processors, single instruction multiple data (SIMD) architecture processors, and single instruction multiple thread (SIMT) architecture processors.

Each layer processes and transforms input data—for example, raw data input into an input layer or the transformed data passed between hidden layers. This transformation process involves the use of an output weight matrix, which is held in memory (e.g., memory 605) and manipulated by the central processing unit (CPU) 645 and/or the parallel processors 615.

In some instances, such layers may be distributed across multiple processing units within a system. For instance, different layers or groups of layers may be executed on different compute units 625 within a single parallel processor 615, or even across multiple parallel processors if warranted by system architecture and the complexity of the neural network.

The output of each layer, after processing and transformation, serves as input for the subsequent layer. In the case of the final output layer, it produces the results or predictions of the neural network. In various embodiments, such results can be utilized by the system or fed back into the network as part of a training or fine-tuning process. In some embodiments, the training or fine-tuning process involves adjusting one or more weights in the output weight matrix associated with each layer to optimize or otherwise improve’ performance of the neural network.

One or more of the elements described above is circuitry designed and configured to perform the corresponding operations described above. Such circuitry, in at least some implementations, is any one of, or a combination of, a hardcoded circuit (e.g., a corresponding portion of an application specific integrated circuit (ASIC) or a set of logic gates, storage elements, and other components selected and arranged to execute the ascribed operations), a programmable circuit (e.g., a corresponding portion of a field programmable gate array (FPGA) or programmable logic device (PLD)), or one or more processors executing software instructions that cause the one or more processors to implement the ascribed actions. In some implementations, the circuitry for a particular element is selected, arranged, and configured by one or more computer-implemented design tools. For example, in some implementations the sequence of operations for a particular element is defined in a specified computer language, such as a register transfer language, and a computer-implemented design tool selects, configures, and arranges the circuitry based on the defined sequence of operations.

Within this disclosure, in some cases, different entities (which are variously referred to as “components,” “units,” “devices,” “circuitry”, etc.) are described or claimed as “configured” to perform one or more tasks or operations. This formulation [entity] configured to [perform one or more tasks]—is used herein to refer to structure (i.e., something physical, such as electronic circuitry). More specifically, this formulation is used to indicate that this physical structure is arranged to perform the one or more tasks during operation. A structure can be said to be “configured to” perform some task even if the structure is not currently being operated. A “memory device configured to store data” is intended to cover, for example, an integrated circuit that has circuitry that stores data during operation, even if the integrated circuit in question is not currently being used (e.g., a power supply is not connected to it). Thus, an entity described or recited as “configured to” perform some task refers to something physical, such as a device, circuitry, memory storing program instructions executable to implement the task, etc. This phrase is not used herein to refer to something intangible. Further, the term “configured to” is not intended to mean “configurable to.” An unprogrammed field programmable gate array, for example, would not be considered to be “configured to” perform some specific function, although it could be “configurable to” perform that function after programming. Additionally, reciting in the appended claims that a structure is “configured to” perform one or more tasks is expressly intended not to be interpreted as having means-plus-function elements.

In some embodiments, the apparatus and techniques described above are implemented in a system including one or more integrated circuit (IC) devices (also referred to as integrated circuit packages or microchips), such as the neural networks and partial neural networks described above with reference to FIGS. 1-5. Electronic design automation (EDA) and computer aided design (CAD) software tools may be used in the design and fabrication of these IC devices. These design tools typically are represented as one or more software programs. The one or more software programs include code executable by a computer system to manipulate the computer system to operate on code representative of circuitry of one or more IC devices so as to perform at least a portion of a process to design or adapt a manufacturing system to fabricate the circuitry. This code can include instructions, data, or a combination of instructions and data. The software instructions representing a design tool or fabrication tool typically are stored in a computer readable storage medium accessible to the computing system. Likewise, the code representative of one or more phases of the design or fabrication of an IC device may be stored in and accessed from the same computer readable storage medium or a different computer readable storage medium.

A computer readable storage medium may include any non-transitory storage medium, or combination of non-transitory storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

In some embodiments, certain aspects of the techniques described above may implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method for processing input data by a multithreaded computing device, the method comprising:
decomposing a sequence of neural network operations of at least one layer of a neural network;
reordering the sequence of neural network operations to form a reordered sequence of operations for the at least one layer; and
processing input data for the at least one layer via the reordered sequence of operations.

2. The method of claim 1, wherein processing the input data for the at least one layer comprises adaptively splitting the input data into multiple segments for parallel processing by multiple processor threads executing the reordered sequence of operations.

3. The method of claim 2, wherein adaptively splitting the input data into multiple segments comprises splitting the input data into K segments, and wherein a maximum activation size of the at least one layer is (C*H/K), wherein C is a context length for the at least one layer and H is a hidden dimension size for the at least one layer.

4. The method of claim 2, wherein processing the data includes sending intermediate data generated via a first portion of the reordered sequence of operations from the multiple processor threads to a shared buffer.

5. The method of claim 4, wherein the first portion of the reordered sequence of operations includes one or more matrix multiplication operations and at least one activation function.

6. The method of claim 4, wherein processing the input data comprises:
parallel processing of the intermediate data from the shared buffer by the multiple processor threads via a second portion of the reordered sequence of operations; and
combining outputs of the multiple processor threads to generate a final output of the at least one layer.

7. The method of claim 6, wherein the generated final output is of a dimensionality that is substantially identical to a dimensionality of the input data.

8. The method of claim 6, wherein the second portion of the reordered sequence of operations comprises a plurality of matrix multiplication operations.

9. The method of claim 1, wherein the sequence of operations comprises a plurality of parameter-independent operations that are not based on learned weights of the at least one layer, and wherein reordering the sequence of operations comprises reordering the parameter-independent operations to be executed prior to any parameter-dependent operations of the at least one layer.

10. A system, comprising:
a memory storing a plurality of layers of a neural network; and
one or more processors to, for at least one layer of the plurality of layers:
decompose a sequence of neural network operations of the at least one layer;
reorder the sequence of neural network operations to form a reordered sequence of operations for the at least one layer; and
process input data for the at least one layer via the reordered sequence of operations.

11. The system of claim 10, wherein to process the input data for the at least one layer comprises to split the input data into multiple segments for parallel processing by multiple processor threads executing the reordered sequence of operations.

12. The system of claim 11, wherein to split the input data into multiple segments comprises to split the input data into K segments, and wherein a maximum activation size of the at least one layer is (C*H/K), wherein C is a context length for the at least one layer and wherein H is a hidden dimension size for the at least one layer.

13. The system of claim 11, wherein to process the input data includes to store intermediate data generated via a first portion of the reordered sequence of operations from the multiple processor threads in a shared buffer that is shared by the multiple processor threads.

14. The system of claim 13, wherein the first portion of the reordered sequence of operations includes one or more matrix multiplication operations and at least one activation function.

15. The system of claim 13, wherein to process the input data includes to:
process in parallel the intermediate data from the shared buffer by the multiple processor threads via a second portion of the reordered sequence of operations; and
combine outputs of the multiple processor threads to generate a final output of the at least one layer.

16. The system of claim 15, wherein the generated final output is of a dimensionality that is substantially identical to a dimensionality of the input data.

17. The system of claim 10, wherein the sequence of operations comprises a plurality of parameter-independent operations that are not based on learned weights of the at least one layer, and wherein to reorder the sequence of neural network operations includes to reorder the parameter-independent operations to be executed prior to any parameter-dependent operations of the at least one layer.

18. A non-transitory computer-readable medium embodying a set of executable instructions, the set of executable instructions to manipulate at least one processor to:
decompose a sequence of neural network operations of at least one layer of a neural network;
reorder the sequence of neural network operations to form a reordered sequence of operations for the at least one layer; and
process input data for the at least one layer via the reordered sequence of operations.

19. The non-transitory computer-readable medium of claim 18, wherein to process the input data for the at least one layer includes to split the input data into multiple segments for parallel processing by multiple processor threads executing the reordered sequence of operations.

20. The non-transitory computer-readable medium of claim 19, wherein splitting the input data into multiple segments comprises splitting the input data into K segments, and wherein a maximum activation size of the at least one layer is (C*H/K), wherein C is a context length for the at least one layer and H is a hidden dimension size for the at least one layer.
